(19) United States
(12) Patent Application Publication
(10) Pub. No.: US 2026/0160907 A1
(43) Pub. Date: Jun. 11, 2026

(54) ARTIFICIAL VIBRATION GENERATION APPARATUS FOR SEISMIC EXPLORATION

(71) Applicant: KOREA INSTITUTE of CIVIL ENGINEERING and BUILDING TECHNOLOGY, Goyang-si (KR)

(72) Inventors: YOUNGSEOK KIM, Seoul (KR); HYUN-JUN CHOI, Seoul (KR); SEUNGJOO LEE, Goyang-si (KR); SEWON KIM, Mokpo-si (KR)

(73) Assignee: KOREA INSTITUTE of CIVIL ENGINEERING and BUILDING TECHNOLOGY, Goyang-si (KR)

(21) Appl. No.: 19/302,118

(22) Filed: Aug. 18, 2025

(30) Foreign Application Priority Data
Dec. 9, 2024 (KR) 10-2024-0181600

(51) Int. Cl. G01V 1/147; G01V 1/053; G01V 1/153

(52) U.S. Cl. CPC G01V 1/147; G01V 1/053; G01V 1/153; G01V 2210/1295

(57) ABSTRACT

The present invention may provide an artificial vibration generation apparatus for seismic exploration, the artificial vibration generation apparatus including: a support piece installed on an installation target surface and subjected to impact, and an impact unit provided with a hammer for generating impact force against the support piece; a support unit provided with a bottom surface in contact with an installation target surface, and an impact unit provided with a hammer for generating impact force against the top surface of the support piece; or a support piece provided with a first surface that comes into contact with an installation target surface perpendicularly, and an impact unit provided with a hammer for generating impact force against a second surface of the support piece formed opposite the first surface.

### CROSS-REFERENCE TO RELATED APPLICATION

This application claims the benefit of Korean Patent Application No. 10-2024-0181600 filed on December 9, 2024, which is hereby incorporated by reference herein in its entirety.

### BACKGROUND

### 1. Technical Field

The present invention relates to an artificial vibration generation apparatus for seismic exploration. More specifically, the present invention relates to an artificial vibration generation apparatus for seismic exploration that enables the effective analysis of the physical properties (density, elasticity, etc.) of underground strata for underground structure exploration using seismic waves, also provides a technology that overcomes problems inherent in a conventional impact hammer method and enables more reliable and safer underground exploration, and may be utilized in various fields of ground investigation, such as ground stability assessment, resource exploration, and the diagnoses of underground structures.

### 2. Description of the Related Art

Seismic exploration is a type of non-destructive exploration, and utilizes the principle that seismic waves are reflected and refracted as they pass through the ground, depending on differences in density and elasticity.

That is, in seismic exploration, seismic waves generated from a vibration source propagate underground. When they encounter strata with varying density or properties, some are reflected, while others are transmitted and refracted. The reflected seismic waves are detected by a receiver and analyzed to determine the underground structure.

Generally, a seismic exploration system includes a vibration source, a receiver, and a data logger.

The vibration source is a device that artificially generates seismic waves at the ground surface and propagates them underground. These seismic waves may be generated using mechanical impact, electromagnetic pulses, explosion, or the like.

The seismic waves generated by the vibration source include primary waves (P waves) and secondary waves (S waves). The P waves propagate through the compression and expansion of the medium, while the S waves propagate through the transverse vibration of the medium.

In this case, the P waves (the longitudinal waves) propagate through the compression and expansion of the medium, and may be generated by applying impact to the ground surface in the vertical direction.

The S waves (the transverse waves) vibrate the medium in the crustal direction, and may be generated by applying impact to the ground surface in the horizontal direction.

These characteristics are used to determine the physical properties (density, composition, elasticity, etc.) of the strata through seismic exploration.

Currently, the seismic exploration of the shallow ground primarily employs an impact hammer to generate seismic waves, and a method of applying impact to a support plate such as a steel plate to transmit seismic waves underground is generally adopted.

The conventional impact hammer method has various limitations.

First, the reliability of measurement data decreases due to the inconsistent magnitude and direction of vibrations, which vary depending on the experimenter's skill level.

In addition, the cable configured to connect the impact hammer and the support plate reduces work convenience.

Furthermore, there is a possibility that a safety-related accident occurs as the support plate may fly off after impact.

Additionally, there are limitations to deep-level exploration due to restrictions on the magnitude of vibrations generated by the impact hammer.

The examples conceived from the above-described perspective include the "Complex Surface Wave Exploration-Type Continuous Monitoring Method" (hereinafter referred to as the "prior art") disclosed in Korean Patent Registration No. 10-1762364.

The prior art has proposed a system in which active exploration and passive exploration are combined together to ensure the stability of the monitoring target.

However, the prior art has low economic efficiency because the costs for constructing and operating the equipment required for continuous monitoring are high.

In addition, the prior art has low system flexibility under diverse environmental conditions, limiting its application to specific purposes.

### SUMMARY

The present invention has been conceived to mitigate the above-described problems, and an object of the present invention is to provide an artificial vibration generation apparatus for seismic exploration with excellent general-purpose capability that enables the exploration of underground structures using seismic waves based on P- and S-wave generation with a single apparatus.

In order to accomplish the above object, the present invention may provide an artificial vibration generation apparatus for seismic exploration, the artificial vibration generation apparatus including: a support piece installed on an installation target surface and subjected to impact, and an impact unit provided with a hammer for generating impact force against the support piece; a support unit provided with a bottom surface in contact with an installation target surface, and an impact unit provided with a hammer for generating impact force against the top surface of the support piece; or a support piece provided with a first surface that comes into contact with an installation target surface perpendicularly, and an impact unit provided with a hammer for generating impact force against a second surface of the support piece formed opposite the first surface.

In this case, vibrations generated by the impact force applied to the support piece by the hammer may be P waves or S waves.

Alternatively, vibrations generated by the impact force applied to the support piece by the hammer may be P waves.

Alternatively, vibrations generated by the impact force applied to the support piece by the hammer may be S waves.

Furthermore, the artificial vibration generation apparatus may further include a support unit extending from one side of the support piece and installed on the installation target surface, the support unit may have a rotatable and foldable structure, and, with respect to one end of the impact unit connected to the hammer, the other end of the impact unit may be connected to one side of the support unit.

Furthermore, the support unit may include: a first frame connected to one edge of the support piece; a second frame, with respect to one edge of the first frame to which the support piece is connected, provided with one end coupled from the other edge of the first frame in a direction perpendicular to the first frame; a first reinforcing frame configured to interconnect one end of the first frame and the other end of the second frame; a second reinforcing frame configured to interconnect the other end of the first frame and the other end of the second frame; rubber coating layers formed on the bottom surfaces of the first frame, the second frame, the first reinforcing frame, and the second reinforcing frame, respectively, to prevent slipping on the installation target surface; a rotation support bracket provided on the other end of the top surface of the second frame and configured to rotatably support the other end of the impact unit; and a rotation support pin configured to penetrate and couple the rotation support bracket and the other end of the impact unit and to rotatably support the other end of the impact unit with respect to the rotation support bracket; the bottom surfaces of the first frame, the second frame, the first reinforcing frame, and the second reinforcing frame may face the installation target surface; and the other end of the impact unit, formed on an opposite side of the one end of the impact unit connected to the hammer, may be rotatably coupled to the other end of the second frame.

Furthermore, the support unit may include: a first frame, with respect to a cut surface formed by excavating the installation target surface to a predetermined depth and configured to meet the installation target surface perpendicularly, connected to one edge of the support piece having a first surface in contact with the cut surface, and placed on the installation target surface; a second frame provided with, with respect to one edge of the first frame to which the support piece is connected, one end coupled from the other edge of the first frame in a direction perpendicular to the first frame, and configured to meet the installation target surface perpendicularly; a first reinforcing frame configured to interconnect one end of the first frame and the other end of the second frame; a second reinforcing frame configured to interconnect the other end of the first frame and the other end of the second frame; a first support frame connected perpendicularly to the one end of the first frame, and placed on the installation target surface; a second support frame connected perpendicularly to the other end of the first frame, and placed on the installation target surface; rubber coating layers formed on the bottom surfaces of the first and second support frames to prevent slipping on the installation target surface; a rotation support bracket provided on the other end of the top surface of the second frame, and configured to rotatably support the other end of the impact unit; and a rotation support pin configured to penetrate and couple the rotation support bracket and the other end of the impact unit and to rotatably support the other end of the impact unit with respect to the rotation support bracket; the hammer may apply impact to a second surface of the support piece formed opposite a first surface of the support piece; and the other end of the impact unit formed opposite the one end of the impact unit connected to the hammer may be rotatably connected to the other end of the second frame.

The impact unit may include a rotation bar, with respect to a support unit provided with one end extending from one side of the support piece and installed on the installation target surface, rotatably coupled to the other end of the support unit; and the hammer may include hammers having different sizes and weights that are detachably coupled to the rotation bar.

Furthermore, the artificial vibration generation apparatus may further include a first driving actuator connected to one end of the rotation support pin and configured to generate driving force used to adjust the angle of the rotation bar of the impact unit, which is connected to the hammer, with respect to the first frame and rotate the rotation bar.

Furthermore, the artificial vibration generation apparatus may further include: a first driving actuator connected to one end of the rotation support pin and configured to generate driving force used to adjust the angle of the rotation bar of the impact unit connected to the hammer with respect to the second frame and to rotate the rotation bar; a reciprocation rail formed to interconnect both ends of the second frame; a second driving actuator connected to the support piece, and configured to generate driving force used to reciprocate the support piece along the reciprocation rail; a support rod provided on one side of the second frame, arranged parallel to the second frame, and configured to be rotatable while being adjustable in length; and an excavation drill connected to the lower end of the support rod, configured to be rotatable together with the support rod, and configured to forming a cut surface while excavating the installation target surface.

Additionally, the artificial vibration generation apparatus may further include: a support frame connected to one side of the second frame and rotatably fixed to the second frame perpendicularly while being rotatable; a third driving actuator connected to the upper end of the support rod coupled to the support frame, and configured to generate driving force used to rotate the support rod and the excavation drill; and a fourth driving actuator provided on one side of the support frame, and configured to generate fluid pressure to adjust the length of the support rod formed in a telescopic structure.

Moreover, the impact unit may further include: a hammer cable embedded in the hammer; and a rotation bar, with respect to a support unit provided with one end extending from one side of the support piece and installed on the installation target surface, rotatably coupled to the other end of the support unit; and the hammer may include hammers having different sizes and weights that are detachably screw-coupled to the rotation bar.

According to the present invention configured as described above, the following effects may be achieved.

First, according to the present invention, the integrated structure of the hammer and the support plate and the fixation pin of the rotation unit ensure that the magnitude and direction of vibration are maintained consistently. Accordingly, this prevents data inconsistencies attributable to the experimenter's skill level, thereby providing more reliable exploration data.

In addition, according to the present invention, rubber coating processing is applied to prevent slipping on the installation target surface, and the rebound phenomenon of the support plate is suppressed after impact.

In addition, the present invention ensures the safety of the experimenter by minimizing damage that may occur during operation by placing the cable inside the hammer. Accordingly, this structural stability prevents safety-related accidents and increases work efficiency.

In addition, the present invention allows for the easy adjustment of weight through the hammer secured by a screw thread method, so that adaptation can be made to various ground conditions and survey depth requirements, thereby achieving high performance even in deep-ground exploration.

In addition, the present invention is designed to generate both P waves and S waves, so that simple switching between the two types of seismic waves can be performed by simply rotating the apparatus 90 degrees. Accordingly, this allows the single apparatus to adapt to various survey environments and enhances its usability in research and practical use.

Furthermore, according to the present invention, the configuration of the present invention includes a foldable design for the equipment, which facilitates the transport and storage of the equipment after experiments, thereby reducing the repair and maintenance costs of the equipment and simplifying the experimental preparation process.

Furthermore, the present invention reduces experimental time and labor input due to its consistent and stable vibration generation. Furthermore, its high survey accuracy reduces the need for additional data correction or re-surveying, thereby significantly enhancing economic efficiency.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a conceptual perspective view showing a state in which an artificial vibration generation apparatus for seismic exploration according to one embodiment of the present invention is installed on an installation target surface; and

FIG. 2 is a conceptual perspective view showing a state in which an artificial vibration generation apparatus for seismic exploration according to another embodiment of the present invention is installed on an installation target surface.

### DETAILED DESCRIPTION

The advantages and features of the present invention and methods for achieving them will become apparent by referring to embodiments to be described below in detail in conjunction with the accompanying drawings.

However, the present invention is not limited to the embodiments to be disclosed below, and may be implemented in various different forms.

In the present specification, the embodiments are provided to make the disclosure of the present invention complete and to fully convey the scope of the invention to those having ordinary skill in the art to which the present invention pertains.

Furthermore, the present invention is defined solely by the scope of the claims.

Accordingly, in some embodiments, well-known components, well-known operations, and well-known techniques are not described in greater detail in order to avoid ambiguity in the interpretation of the present invention.

Furthermore, throughout the specification, the same reference numerals denote the same components, and the terms used (or described) herein are intended to describe embodiments and are not intended to limit the present invention.

In the present specification, singular forms include plural formed unless specifically stated otherwise, and components and operations referred to as "including (or comprising)" do not exclude the presence or addition of one or more other components and operations.

Unless otherwise defined, all the terms (including technical and scientific terms) used herein may be used in senses that are commonly understood by those having ordinary skill in the art to which the present invention pertains.

Furthermore, the terms defined in commonly used dictionaries should not be interpreted in an idealistic or excessive manner unless otherwise defined.

Preferred embodiments of the present invention will be described below with reference to the accompanying drawings.

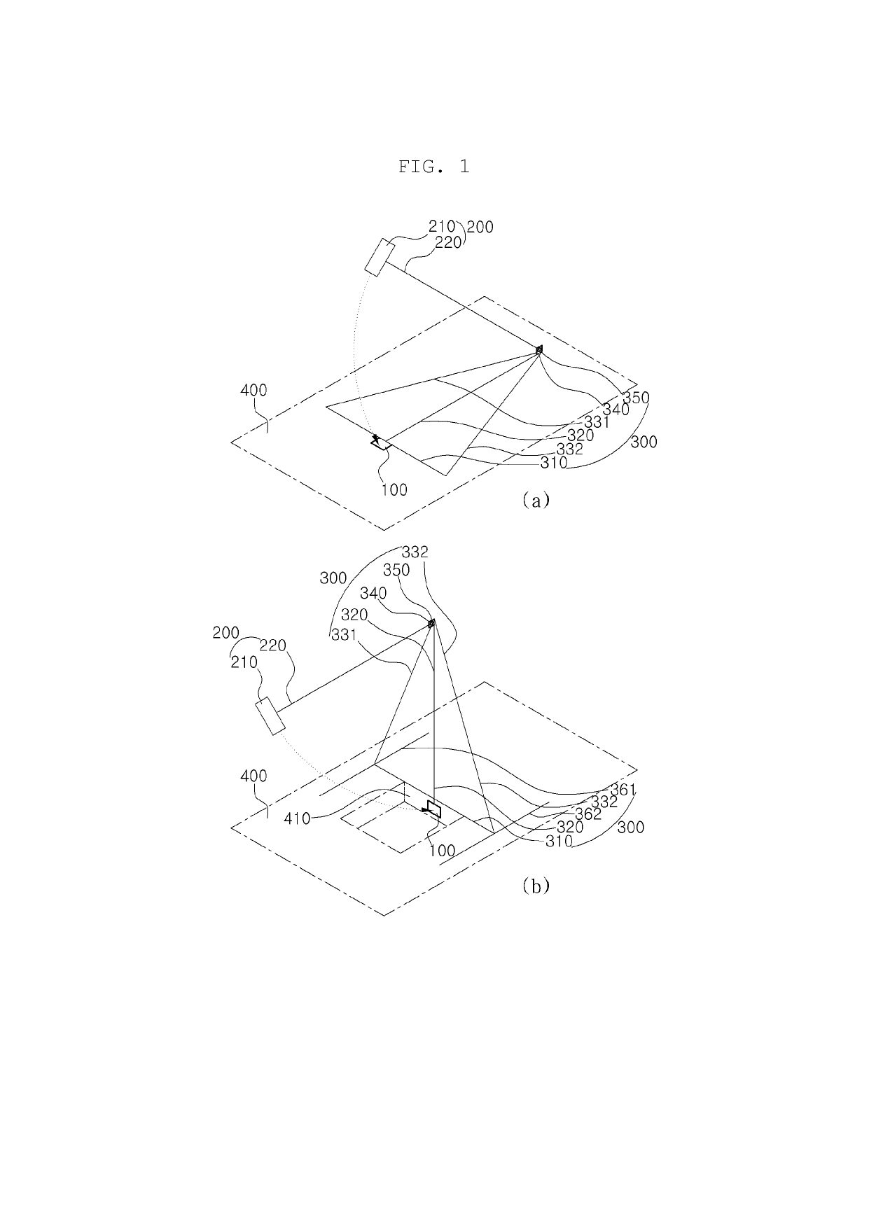

First, FIG. 1 is a conceptual perspective view showing a state in which an artificial vibration generation apparatus for seismic exploration according to one embodiment of the present invention is installed on an installation target surface 400.

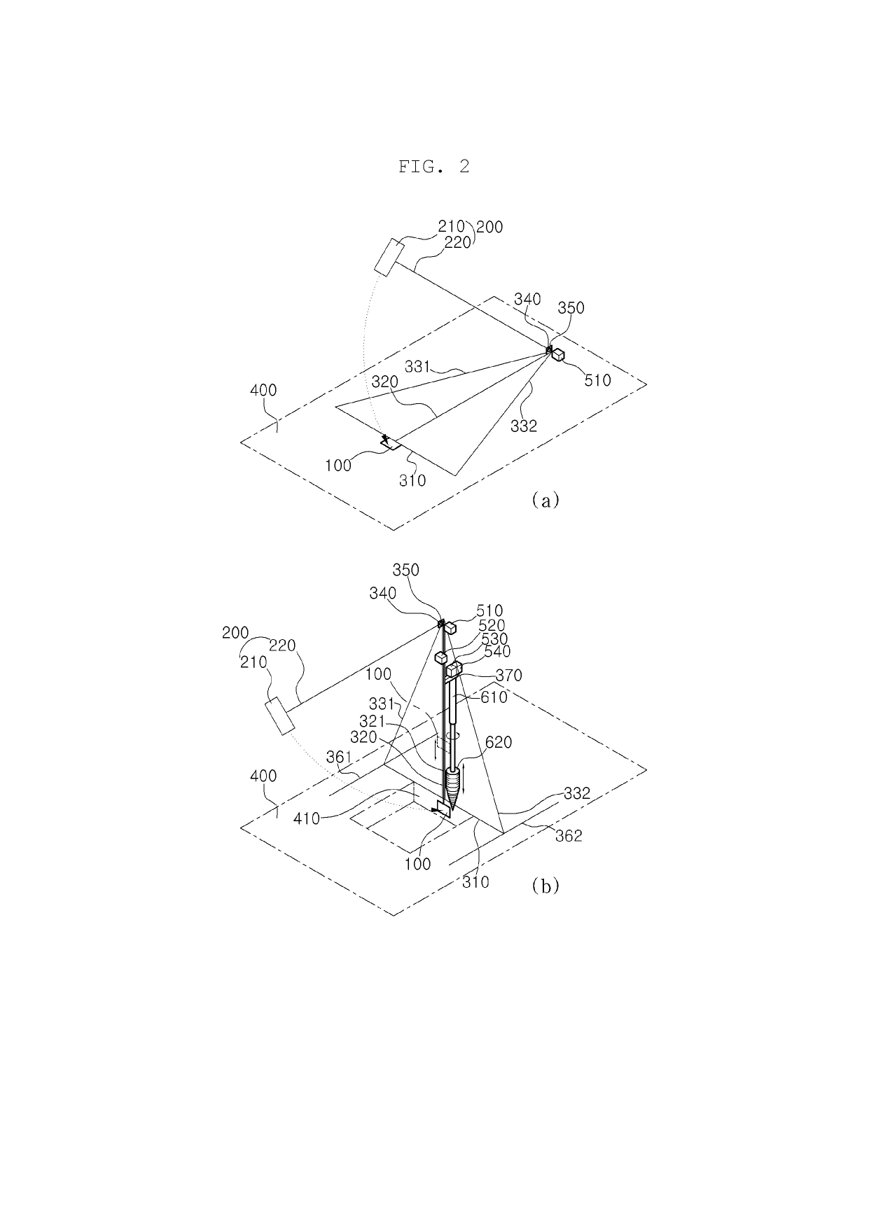

Furthermore, FIG. 2 is a conceptual perspective view showing a state in which an artificial vibration generation apparatus for seismic exploration according to another embodiment of the present invention is installed on an installation target surface 400.

For reference, the dotted curved arrows shown in FIGS. 1 and 2 indicate the directions in which impact force is applied to a support piece 100 by a hammer 210.

First, the present invention may include the support piece 100 installed on the installation target surface 400 and configured to be struck, and an impact unit 200 provided with the hammer 210 that generates impact force against the support piece 100, as shown in FIGS. 1 and 2.

Furthermore, an artificial vibration generation apparatus for seismic exploration according to one embodiment of the present invention may include the support piece 100 provided with a bottom surface that comes into contact with the installation target surface 400 to generate P waves, and the impact unit 200 provided with the hammer 210 for generating impact force against the top surface of the support piece 100, as shown in FIG. 1(a).

In addition, an artificial vibration generation apparatus for seismic exploration according to another embodiment of the present invention may include the support piece 100 provided with a first surface that comes into contact with the installation target surface 400 perpendicularly to generate S-waves, and the impact unit 200 provided with the hammer 210 for generating impact force against the second surface of the support piece 100 formed opposite the first surface, as shown in FIG. 1(b).

The present invention may be applied to the above-described embodiments, and are also applicable to the following various embodiments.

First, the vibrations generated by the impact force applied by the hammer 210 to the support piece 100 may be P waves, as shown in FIG. 1(a), or S waves, as shown in FIG. 1(b).

Meanwhile, the artificial vibration generation apparatus for seismic exploration according to the present invention further includes the support unit 300 extending from one side of the support piece 100 and installed on the installation target surface 400. The support unit 300 has a rotatable and foldable structure. One end of the impact unit 200 is connected to the hammer 210, while the other end of the impact unit 200 is connected to one side of the support unit 300.

That is, the support unit 300 may be fabricated in a rotatable and foldable structure to minimize overall volume for the purpose of convenient storage and transportation. More specifically, the support unit 300 may be fabricated in a structure that is equally folded with respect to the portion where a first frame 310 to be described later is connected with a second frame 320.

Meanwhile, the support unit 300 may include the first frame 310 connected to one edge of the support piece 100, and the second frame 320 provided with one end coupled from the other edge of the first frame 310 in a direction perpendicular to the first frame 310 with respect to one edge of the first frame 310 to which the support piece 100 is connected, as shown in FIG. 1(a).

Furthermore, the support unit 300 may include a first reinforcing frame 331 configured to interconnect one end of the first frame 310 with the other end of the second frame 320, and a second reinforcing frame 332 configured to interconnect the other end of the first frame 310 with the other end of the second frame 320.

Furthermore, the support unit 300 may include rubber coating layers (not shown) formed on the bottom surfaces of the first frame 310, the second frame 320, the first reinforcing frame 331, and the second reinforcing frame 332 to prevent slipping on the installation target surface 400.

Furthermore, the support unit 300 may include a rotation support bracket 340 provided on the other end of the upper surface of the second frame 320 and configured to rotatably support the other end of the impact unit 200, and a rotation support pin 350 configured to penetrate and couple the rotation support bracket 340 and the other end of the impact unit 200 and to rotatably support the other end of the impact unit 200 with respect to the rotation support bracket 340.

In this case, the bottom surfaces of the first frame 310, the second frame 320, the first reinforcing frame 331, and the second reinforcing frame 332 face the installation target surface 400, and the other end of the impact unit 200, formed opposite one end of the impact unit 200 connected to the hammer 210, may be rotatably connected to the other end of the second frame 320.

Meanwhile, with respect to a cut surface 410 formed by excavating the installation target surface 400 to a predetermined depth and configured to meet the installation target surface 400 perpendicularly, as shown in FIG. 1(b), the support unit 300 may include a first frame 310 connected to one edge of a support piece 100 having a first surface in contact with the cut surface 410 and placed on the installation target surface 400.

In addition, the support unit 300 may include a second frame 320 provided with one end coupled in a direction perpendicular to the first frame 310 from the other edge of the first frame 310 with respect to one edge of the first frame 310 to which the support piece 100 is connected and configured to meet the installation target surface 400 perpendicularly.

The support unit 300 may include the first reinforcing frame 331 configured to interconnect one end of the first frame 310 and the other end of the second frame 320, and the second reinforcing frame 332 configured to interconnect the other end of the first frame 310 and the other end of the second frame 320.

In addition, the support unit 300 may include a first support frame 361 connected perpendicularly to one end of the first frame 310 and placed on the installation target surface 400, and a second support frame 362 connected perpendicularly to the other end of the first frame 310 and placed on the installation target surface 400.

In addition, the support unit 300 may include rubber coating layers (not shown) formed on the bottom surfaces of the first support frame 361 and the second support frame 362 to prevent slipping on the installation target surface 400.

Furthermore, the support unit 300 may include a rotation support bracket 340 provided on the other end of the top surface of the second frame 320 and configured to rotatably support the other end of the impact unit 200, and a rotation support pin 350 configured to penetrate and couple the rotation support bracket 340 and the other end of the impact unit 200 and to rotatably support the other end of the impact unit 200 with respect to the rotation support bracket 340.

In this case, it can be seen that the hammer 210 applies impact to a second surface formed on a side opposite the first surface of the support piece 100, and the other end of the impact unit 200, formed opposite one end of the impact unit 200 connected to the hammer 210, is rotatably connected to the other end of the second frame 320.

Meanwhile, with regard to the support unit 300 provided with one end extending from one side of the support piece 100 and installed on the installation target surface 400, the impact unit 200 may include a rotation bar 220 rotatably coupled to the other end of the support unit 300.

In this case, there may be applied embodiments in which hammers 210 with different sizes and weights are detachably coupled to the rotation bar 220.

Meanwhile, an artificial vibration generation apparatus for seismic exploration according to another embodiment of the present invention may further include a first driving actuator 510 configured to automatically generate P waves, as shown in FIG. 2(a).

The first driving actuator 510 is connected to one end of the rotation support pin 350, and generates driving force used to adjust the angle of the rotation bar 220 of the impact unit 200, which is connected to the hammer 210, with respect to the first frame 310 and rotate the rotation bar 220.

Meanwhile, the artificial vibration generation apparatus for seismic exploration according to the other embodiment of the present invention may further include the first driving actuator 510 connected to one end of the rotation support pin 350 and configured to generate driving force used to adjust the angle of the rotation bar 220 of the impact unit 200, which is connected to the hammer 210, with respect to the second frame 320 and rotate the rotation bar 220 in order to automatically generate S waves, as shown in FIG. 2(b).

In addition, the present invention may further include a reciprocation rail 321 formed by interconnecting both ends of the second frame 320, and a second driving actuator 520 connected to the support piece 100 and configured to generate driving force that causes the support piece 100 to reciprocate along the reciprocation rail 321, as shown in the drawing.

In addition, the present invention may further include a support rod 610 provided on one side of the second frame 320, arranged parallel to the second frame 320 and configured to be adjustable in length and rotatable, and an excavation drill 620 coupled to the lower end of the support rod 610, configured to be rotated together with the support rod 610 in an integrated manner and also configured to form cut surfaces 410 while excavating the installation target surface 400.

In this case, the support unit 300 according to the present invention may further include a support frame 370 connected to one side of the second frame 320 and configured to be rotatable and rotatably fixed perpendicularly to the second frame 320.

In this case, the support unit 300 may further include a third driving actuator 530 connected to the upper end of the support rod 610 coupled to the support frame 370 and configured to generate driving force that rotates the support rod 610 and the excavation drill 620.

Furthermore, the support unit 300 may further include a fourth driving actuator 540 installed on one side of the support frame 370 and configured to generate fluid pressure to adjust the length of the support rod 610 formed in a telescopic structure.

Meanwhile, with regard to the support unit 300 provided with one end extending from one side of the support piece 100 and installed on the installation target surface 400, the impact unit 200 may further include a hammer cable (not shown) embedded in the hammer 210, and a rotation bar 220 rotatably connected to the other end of the support unit 300.

In this case, as previously described, the hammers 210 with different sizes and weights may be detachably screw-coupled to the rotation bar 220.

As described above, it can be seen that the basic technical spirit of the present invention is to provide an artificial vibration generation apparatus for seismic exploration with excellent general-purpose capability that enables the exploration of underground structures using seismic waves based on P- and S-wave generation with a single apparatus.

In addition, it should be readily apparent to those skilled in the art that numerous other modifications and applications are possible within the scope of the fundamental technical concept of the present invention.

What is claimed is:

1. An artificial vibration generation apparatus for seismic exploration, the artificial vibration generation apparatus comprising:
a support piece installed on an installation target surface and subjected to impact; and
an impact unit provided with a hammer for generating impact force against the support piece.

2. An artificial vibration generation apparatus for seismic exploration, the artificial vibration generation apparatus comprising:
a support unit provided with a bottom surface in contact with an installation target surface; and
an impact unit provided with a hammer for generating impact force against a top surface of the support piece.

3. An artificial vibration generation apparatus for seismic exploration, the artificial vibration generation apparatus comprising:
a support piece provided with a first surface that comes into contact with an installation target surface perpendicularly; and
an impact unit provided with a hammer for generating impact force against a second surface of the support piece formed opposite the first surface.

4. The artificial vibration generation apparatus of claim 1, wherein vibrations generated by the impact force applied to the support piece by the hammer are P waves or S waves.

5. The artificial vibration generation apparatus of claim 2, wherein vibrations generated by the impact force applied to the support piece by the hammer are P waves.

6. The artificial vibration generation apparatus of claim 3, wherein vibrations generated by the impact force applied to the support piece by the hammer are S waves.

7. The artificial vibration generation apparatus of claim 1, further comprising a support unit extending from one side of the support piece and installed on the installation target surface;
wherein the support unit has a rotatable and foldable structure; and
wherein, with respect to one end of the impact unit connected to the hammer, a remaining end of the impact unit is connected to one side of the support unit.

8. The artificial vibration generation apparatus of claim 2, further comprising a support unit extending from one side of the support piece and installed on the installation target surface;
wherein the support unit has a rotatable and foldable structure; and
wherein, with respect to one end of the impact unit connected to the hammer, a remaining end of the impact unit is connected to one side of the support unit.

9. The artificial vibration generation apparatus of claim 3, further comprising a support unit extending from one side of the support piece and installed on the installation target surface;
wherein the support unit has a rotatable and foldable structure; and
wherein, with respect to one end of the impact unit connected to the hammer, a remaining end of the impact unit is connected to one side of the support unit.

10. The artificial vibration generation apparatus of claim 7, wherein the support unit comprises:
a first frame connected to one edge of the support piece;
a second frame, respect to one edge of the first frame to which the support piece is connected, provided with one end coupled from a remaining edge of the first frame in a direction perpendicular to the first frame with;
a first reinforcing frame configured to interconnect one end of the first frame and a remaining end of the second frame;
a second reinforcing frame configured to interconnect a remaining end of the first frame and the remaining end of the second frame;
rubber coating layers formed on bottom surfaces of the first frame, the second frame, the first reinforcing frame, and the second reinforcing frame, respectively, to prevent slipping on the installation target surface;
a rotation support bracket provided on a remaining end of a top surface of the second frame and configured to rotatably support the remaining end of the impact unit; and
a rotation support pin configured to penetrate and couple the rotation support bracket and the remaining end of the impact unit and to rotatably support the remaining end of the impact unit with respect to the rotation support bracket;
wherein the bottom surfaces of the first frame, the second frame, the first reinforcing frame, and the second reinforcing frame face the installation target surface; and
wherein the remaining end of the impact unit, formed on an opposite side of the one end of the impact unit connected to the hammer, is rotatably coupled to the remaining end of the second frame.

11. The artificial vibration generation apparatus of claim 7, wherein the support unit comprises:
a first frame, with respect to a cut surface formed by excavating the installation target surface to a predetermined depth and configured to meet the installation target surface perpendicularly, connected to one edge of the support piece having a first surface in contact with the cut surface, and placed on the installation target surface;
a second frame provided with, with respect to one edge of the first frame to which the support piece is connected, one end coupled from a remaining edge of the first frame in a direction perpendicular to the first frame, and configured to meet the installation target surface perpendicularly;
a first reinforcing frame configured to interconnect one end of the first frame and a remaining end of the second frame;
a second reinforcing frame configured to interconnect a remaining end of the first frame and the remaining end of the second frame;
a first support frame connected perpendicularly to the one end of the first frame, and placed on the installation target surface;
a second support frame connected perpendicularly to the remaining end of the first frame, and placed on the installation target surface;
rubber coating layers formed on bottom surfaces of the first and second support frames to prevent slipping on the installation target surface;
a rotation support bracket provided on a remaining end of a top surface of the second frame, and configured to rotatably support the remaining end of the impact unit; and
a rotation support pin configured to penetrate and couple the rotation support bracket and the remaining end of the impact unit and to rotatably support the remaining end of the impact unit with respect to the rotation support bracket;
wherein the hammer applies impact to a second surface of the support piece formed opposite a first surface of the support piece; and
wherein the remaining end of the impact unit formed opposite the one end of the impact unit connected to the hammer is rotatably connected to the remaining end of the second frame.

12. The artificial vibration generation apparatus of claim 1, wherein:
the impact unit comprises a rotation bar, with respect to a support unit provided with one end extending from one side of the support piece and installed on the installation target surface, rotatably coupled to the remaining end of the support unit; and
the hammer comprises hammers having different sizes and weights that are detachably coupled to the rotation bar.

13. The artificial vibration generation apparatus of claim 2, wherein:
the impact unit comprises a rotation bar, with respect to a support unit provided with one end extending from one side of the support piece and installed on the installation target surface, rotatably coupled to the remaining end of the support unit; and
the hammer comprises hammers having different sizes and weights that are detachably coupled to the rotation bar.

14. The artificial vibration generation apparatus of claim 3, wherein:
the impact unit comprises a rotation bar, with respect to a support unit provided with one end extending from one side of the support piece and installed on the installation target surface, rotatably coupled to the remaining end of the support unit; and
the hammer comprises hammers having different sizes and weights that are detachably coupled to the rotation bar.

15. The artificial vibration generation apparatus of claim 10, further comprising a first driving actuator connected to one end of the rotation support pin and configured to generate driving force used to adjust an angle of a rotation bar of the impact unit, which is connected to the hammer, with respect to the first frame and rotate the rotation bar.

16. The artificial vibration generation apparatus of claim 11, further comprising:
a first driving actuator connected to one end of the rotation support pin and configured to generate driving force used to adjust an angle of a rotation bar of the impact unit connected to the hammer with respect to the second frame and to rotate the rotation bar;
a reciprocation rail formed to interconnect both ends of the second frame;
a second driving actuator connected to the support piece, and configured to generate driving force used to reciprocate the support piece along the reciprocation rail;
a support rod provided on one side of the second frame, arranged parallel to the second frame, and configured to be rotatable while being adjustable in length; and
an excavation drill connected to a lower end of the support rod, configured to be rotatable together with the support rod, and configured to forming a cut surface while excavating the installation target surface.

17. The artificial vibration generation apparatus of claim 16, further comprising:
a support frame connected to one side of the second frame and rotatably fixed to the second frame perpendicularly while being rotatable;
a third driving actuator connected to an upper end of the support rod coupled to the support frame, and configured to generate driving force used to rotate the support rod and the excavation drill; and
a fourth driving actuator provided on one side of the support frame, and configured to generate fluid pressure to adjust a length of the support rod formed in a telescopic structure.

18. The artificial vibration generation apparatus of claim 1, wherein the impact unit further comprises:
a hammer cable embedded in the hammer; and
a rotation bar, with respect to a support unit provided with one end extending from one side of the support piece and installed on the installation target surface, rotatably coupled to a remaining end of the support unit;
wherein the hammer comprises hammers having different sizes and weights that are detachably screw-coupled to the rotation bar.

19. The artificial vibration generation apparatus of claim 2, wherein the impact unit further comprises:
a hammer cable embedded in the hammer; and
a rotation bar, with respect to a support unit provided with one end extending from one side of the support piece and installed on the installation target surface, rotatably coupled to a remaining end of the support unit;
wherein the hammer comprises hammers having different sizes and weights that are detachably screw-coupled to the rotation bar.

20. The artificial vibration generation apparatus of claim 3, wherein the impact unit further comprises:
a hammer cable embedded in the hammer; and
a rotation bar, with respect to a support unit provided with one end extending from one side of the support piece and installed on the installation target surface, rotatably coupled to a remaining end of the support unit;
wherein the hammer comprises hammers having different sizes and weights that are detachably screw-coupled to the rotation bar.
